(19) United States
(12) Patent Application Publication
(10) Pub. No.: US 2025/0266944 A1
(43) Pub. Date: Aug. 21, 2025

(54) ORTHOGONAL COVER CODES FOR CLUSTERS IN NON-TERRESTRIAL NETWORKS

(71) Applicant: QUALCOMM Incorporated, San Diego, CA (US)

(72) Inventors: Syed Hashim Ali SHAH, San Diego, CA (US); Alberto RICO ALVARINO, San Diego, CA (US); Xiao Feng WANG, San Diego, CA (US); Liangping MA, San Diego, CA (US); Ayan SENGUPTA, San Diego, CA (US)

(21) Appl. No.: 19/013,897

(22) Filed: Jan. 8, 2025

Related U.S. Application Data
(60) Provisional application No. 63/554,438, filed on Feb. 16, 2024.

(51) Int. Cl. H04L 5/00; H04J 13/00

(52) U.S. Cl. CPC H04L 5/0016; H04L 5/0053; H04J 13/004

(57) ABSTRACT

Methods, systems, and devices for wireless communications are described. A user equipment (UE) may transmit an indication of a capability of the UE to support orthogonal cover code (OCC) multiplexing. The UE may receive, based on the indication, control signaling indicating a multiplexing order parameter, an OCC code word that the UE is to apply for OCC multiplexing, and a quantity of units included in each cluster in which the UE is to apply OCC multiplexing. The UE may transmit a plurality of OCC encoded sequences over a plurality of clusters, the OCC code word applied to a plurality of sequences to generate the plurality of OCC encoded sequences in accordance with the multiplexing order parameter and the quantity of units.

### CROSS REFERENCE

The present Application for Patent claims the benefit of U.S. Provisional Patent Application No. 63/554,438 by SHAH et al., entitled “ORTHOGONAL COVER CODES FOR CLUSTERS IN NON-TERRESTRIAL NETWORKS,” filed Feb. 16, 2024, assigned to the assignee hereof, and expressly incorporated by reference in its entirety herein.

### FIELD OF TECHNOLOGY

The following relates to wireless communications, including orthogonal covering codes for clusters in non-terrestrial networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a wireless device may operate in a multiplexing scenario. However, such approaches may be improved.

### SUMMARY

The described techniques relate to improved methods, systems, devices, and apparatuses that support orthogonal covering codes for clusters in non-terrestrial networks. For example, a user equipment (UE) may transmit an indication of a capability of the UE to support orthogonal cover code (OCC) multiplexing. The UE may receive, based on the indication, control signaling indicating a multiplexing order parameter, an OCC code word that the UE is to apply for OCC multiplexing, and a quantity of units included in each cluster in which the UE is to apply OCC multiplexing. The UE may transmit a plurality of OCC encoded sequences via a plurality of clusters, the OCC code word applied to a plurality of sequences to generate the plurality of OCC encoded sequences in accordance with the multiplexing order parameter and the quantity of units.

A method for wireless communications by a UE is described. The method may include transmitting an indication of a capability of the UE to support OCC multiplexing, receiving, based on the indication, control signaling indicating a multiplexing order parameter, an OCC code word that the UE is to apply for OCC multiplexing, and a quantity of units included in each cluster in which the UE is to apply OCC multiplexing, and transmitting, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

A UE for wireless communications is described. The UE may include one or more memories storing processor executable code, a transceiver, and one or more processors coupled with the one or more memories. The one or more processors may individually or collectively be operable to execute the code to cause the UE to transmit an indication of a capability of the UE to support OCC multiplexing, receive, based on the indication, control signaling indicating a multiplexing order parameter, an OCC code word that the UE is to apply for OCC multiplexing, and a quantity of units included in each cluster in which the UE is to apply OCC multiplexing, and transmit, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

Another UE for wireless communications is described. The UE may include means for transmitting an indication of a capability of the UE to support OCC multiplexing, means for receiving, based on the indication, control signaling indicating a multiplexing order parameter, an OCC code word that the UE is to apply for OCC multiplexing, and a quantity of units included in each cluster in which the UE is to apply OCC multiplexing, and means for transmitting, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

A non-transitory computer-readable medium storing code for wireless communications is described. The code may include instructions executable by one or more processors to transmit an indication of a capability of the UE to support OCC multiplexing, receive, based on the indication, control signaling indicating a multiplexing order parameter, an OCC code word that the UE is to apply for OCC multiplexing, and a quantity of units included in each cluster in which the UE is to apply OCC multiplexing, and transmit, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

In some examples of the method, UEs, and non-transitory computer-readable medium described herein, the capability of the UE to support OCC multiplexing may be based on one or more phase coherence capabilities of the UE.

Some examples of the method, UEs, and non-transitory computer-readable medium described herein may further include operations, features, means, or instructions for applying the OCC code word to the set of multiple sequences to generate the set of multiple OCC encoded sequences, where a quantity of the set of multiple OCC encoded sequences corresponds to the multiplexing order parameter.

In some examples of the method, UEs, and non-transitory computer-readable medium described herein, a unit includes a bit, a symbol, a resource element, a mini-slot, or a slot and a cluster of the set of multiple clusters includes a set of multiple symbols, a set of multiple resource elements, a set of multiple mini-slots, or a set of multiple slots.

In some examples of the method, UEs, and non-transitory computer-readable medium described herein, a unit includes a bit and the method, apparatuses, and non-transitory computer-readable medium may include further operations, features, means, or instructions for spreading a first bit or a first bit pair of a first bit sequence of the set of multiple sequences by the OCC code word to generate a first OCC encoded sequence of the set of multiple OCC encoded sequences.

Some examples of the method, UEs, and non-transitory computer-readable medium described herein may further include operations, features, means, or instructions for applying one or more bit flip operations to the first bit or the first bit pair of the set of multiple sequences based on the OCC code word, where the first bit or the first bit pair in the set of multiple sequences may be modulated via binary phase shift keying or quadrature phase shift keying, and where at least one element of the OCC code word indicates a phase shift value corresponding to zero degrees or one-hundred eighty degrees.

In some examples of the method, UEs, and non-transitory computer-readable medium described herein, the multiplexing order parameter may be a factor of a quantity of the set of multiple clusters included in time-frequency resources allocated to the UE for communication of the set of multiple OCC encoded sequences via the set of multiple clusters.

In some examples of the method, UEs, and non-transitory computer-readable medium described herein, transmitting the set of multiple OCC encoded sequences may include operations, features, means, or instructions for transmitting shared channel signaling, control channel signaling, reference signaling, or any combination thereof, that may be generated based on the set of multiple OCC encoded sequences.

In some examples of the method, UEs, and non-transitory computer-readable medium described herein, the OCC code word may be associated with an orthogonal matrix.

In some examples of the method, UEs, and non-transitory computer-readable medium described herein, the set of multiple clusters may be consecutive in time or may be non-consecutive in time.

A method for wireless communications by a network entity is described. The method may include obtaining an indication of a capability of a UE to support OCC multiplexing, outputting, based on the indication, control signaling indicating a multiplexing order parameter, an OCC code word that the UE is to apply for OCC multiplexing, and a quantity of units included in each cluster in which the UE is to apply OCC multiplexing, and obtaining, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

A network entity for wireless communications is described. The network entity may include one or more memories storing processor executable code, and one or more processors coupled with the one or more memories. The one or more processors may individually or collectively be operable to execute the code to cause the network entity to obtain an indication of a capability of a UE to support OCC multiplexing, output, based on the indication, control signaling indicating a multiplexing order parameter, an OCC code word that the UE is to apply for OCC multiplexing, and a quantity of units included in each cluster in which the UE is to apply OCC multiplexing, and obtain, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

Another network entity for wireless communications is described. The network entity may include means for obtaining an indication of a capability of a UE to support OCC multiplexing, means for outputting, based on the indication, control signaling indicating a multiplexing order parameter, an OCC code word that the UE is to apply for OCC multiplexing, and a quantity of units included in each cluster in which the UE is to apply OCC multiplexing, and means for obtaining, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

A non-transitory computer-readable medium storing code for wireless communications is described. The code may include instructions executable by one or more processors to obtain an indication of a capability of a UE to support OCC multiplexing, output, based on the indication, control signaling indicating a multiplexing order parameter, an OCC code word that the UE is to apply for OCC multiplexing, and a quantity of units included in each cluster in which the UE is to apply OCC multiplexing, and obtain, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

In some examples of the method, network entities, and non-transitory computer-readable medium described herein, the indication of the capability of the UE to support OCC multiplexing may be based on one or more phase coherence capabilities of the UE.

In some examples of the method, network entities, and non-transitory computer-readable medium described herein, a quantity of the set of multiple OCC encoded sequences corresponds to the multiplexing order parameter.

In some examples of the method, network entities, and non-transitory computer-readable medium described herein, a unit includes a bit, a symbol, a resource element, a mini-slot, or a slot and a cluster of the set of multiple clusters includes a set of multiple symbols, a set of multiple resource elements, a set of multiple mini-slots, or a set of multiple slots.

In some examples of the method, network entities, and non-transitory computer-readable medium described herein, a unit includes a bit and a first OCC encoded sequence of the set of multiple OCC encoded sequences may be based on a first bit or a first bit pair of a first bit sequence of the set of multiple sequences being spread by the OCC code word.

In some examples of the method, network entities, and non-transitory computer-readable medium described herein, the first OCC encoded sequence of the set of multiple OCC encoded sequences may be based on one or more bit flip operations being applied to the first bit or the first bit pair of the set of multiple sequences in accordance with the OCC code word, the first bit or the first bit pair in the set of multiple sequences may be modulated via binary phase shift keying or quadrature phase shift keying, and at least one element of the OCC code word indicates a phase shift value corresponding to zero degrees or one-hundred eighty degrees.

In some examples of the method, network entities, and non-transitory computer-readable medium described herein, the multiplexing order parameter may be a factor of a quantity of the set of multiple clusters included in time-frequency resources allocated to the UE for communication of the set of multiple OCC encoded sequences over the set of multiple clusters.

In some examples of the method, network entities, and non-transitory computer-readable medium described herein, the set of multiple OCC encoded sequences may be included in shared channel signaling, control channel signaling, reference signaling, or any combination thereof.

In some examples of the method, network entities, and non-transitory computer-readable medium described herein, the OCC code word may be associated with an orthogonal matrix.

### BRIEF DESCRIPTION OF THE DRAWINGS

FIG. 1 shows an example of a wireless communications system that supports orthogonal covering codes for clusters in non-terrestrial networks in accordance with one or more examples as disclosed herein.

FIG. 2 shows an example of a wireless communications system that supports orthogonal covering codes for clusters in non-terrestrial networks in accordance with one or more examples as disclosed herein.

FIG. 3 shows an example of a multiplexing scheme that supports orthogonal covering codes for clusters in non-terrestrial networks in accordance with one or more examples as disclosed herein.

FIGS. 4A and 4B show examples of multiplexing schemes that support orthogonal covering codes for clusters in non-terrestrial networks in accordance with one or more examples as disclosed herein.

FIG. 5 shows an example of a process flow that supports orthogonal covering codes for clusters in non-terrestrial networks in accordance with one or more examples as disclosed herein.

FIGS. 6 and 7 show block diagrams of devices that support orthogonal covering codes for clusters in non-terrestrial networks in accordance with one or more examples as disclosed herein.

FIG. 8 shows a block diagram of a communications manager that supports orthogonal covering codes for clusters in non-terrestrial networks in accordance with one or more examples as disclosed herein.

FIG. 9 shows a diagram of a system including a device that supports orthogonal covering codes for clusters in non-terrestrial networks in accordance with one or more examples as disclosed herein.

FIGS. 10 and 11 show block diagrams of devices that support orthogonal covering codes for clusters in non-terrestrial networks in accordance with one or more examples as disclosed herein.

FIG. 12 shows a block diagram of a communications manager that supports orthogonal covering codes for clusters in non-terrestrial networks in accordance with one or more examples as disclosed herein.

FIG. 13 shows a diagram of a system including a device that supports orthogonal covering codes for clusters in non-terrestrial networks in accordance with one or more examples as disclosed herein.

FIGS. 14 and 15 show flowcharts illustrating methods that support orthogonal covering codes for clusters in non-terrestrial networks in accordance with one or more examples as disclosed herein.

### DETAILED DESCRIPTION

In wireless communications, multiple user equipments (UEs) may communicate with one or more network entities using multiple access schemes that may involve multiplexing of signaling associated with the multiple UEs. However, such multiplexing may cause interference at a network entity, reducing communications quality, reliability, and capacity, as well as increasing latency. Further, operation in non-terrestrial networks (NTNs) may exacerbate such conditions (e.g., due to the distances involved in NTNs).

Techniques for multiple access involving multiple UEs may be employed. For example, a UE communicating with a network entity may engage in orthogonal cover code (OCC) operations in the time domain to mitigate interference. In some examples, OCCs may be applied in the time domain across groups of time-domain units (e.g., symbols, clusters of symbols, mini-slots, slots, one or more other time-domain units, or any combination thereof). For example, a UE may indicate to a network entity that the UE supports the use of OCCs across groups of one or more time-domain units. The network entity may respond with control signaling to indicate to the UE a multiplexing order, a code word or matrix, and a quantity of units that are included in each cluster (e.g., a quantity of symbol periods in a cluster). The UE may then apply the code to signaling in accordance with the multiplexing order, code word, and quantity of units. In this way, communications quality, reliability, and capacity may be increased and latency may be decreased, as multiple UEs may communicate with the network entities at the same time with reduced or eliminated interference. Further, communications protocols and configurations may be simplified and standardized through the coordination of time-domain units used for the OCC multiplexing operations.

Aspects of the disclosure are initially described in the context of wireless communications systems. Aspects of the disclosure are then described with reference to a wireless communications system, multiplexing schemes, and a process flow. Aspects of the disclosure are further illustrated by and described with reference to apparatus diagrams, system diagrams, and flowcharts that relate to orthogonal covering codes for clusters in non-terrestrial networks.

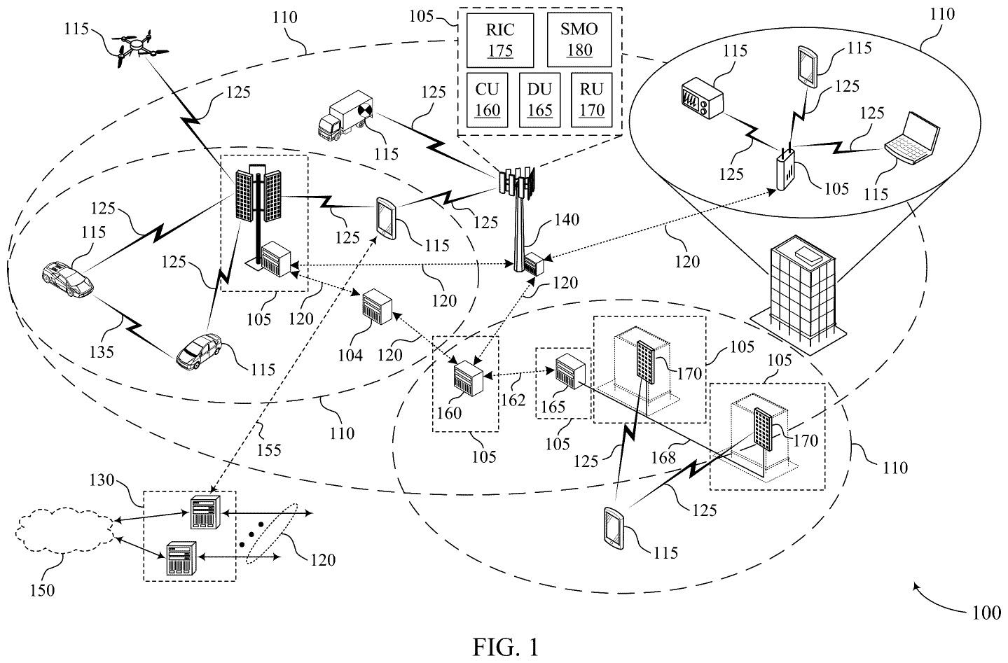

FIG. 1 shows an example of a wireless communications system 100 that supports orthogonal covering codes for clusters in non-terrestrial networks in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of T_{S}=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, such as a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2 communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, a UE 115 and a network entity 105 may support mechanisms according to which the UE 115 and the network entity 105 may perform multiplexing using OCCs, including over NTNs. For example, a UE 115 may signal to a network entity 105 that the UE 115 supports the use of OCCs in multiplexing scenarios, and the network entity 105 may respond with control signaling including parameters for the UE 115 to use in the OCC multiplexing. For example, such parameters may include a multiplexing order, an OCC code word to be used by the UE 115, and an indication of a quantity of units (e.g., bits, symbols, resource elements, mini-slots, slots, or any combination thereof) that are included in clusters of such units. The UE 115 may apply the OCC code word to sequences to generate OCC encoded sequences (e.g., based on or in accordance with the multiplexing order and the quantity of units per cluster) that are transmitted to the network entity 105.

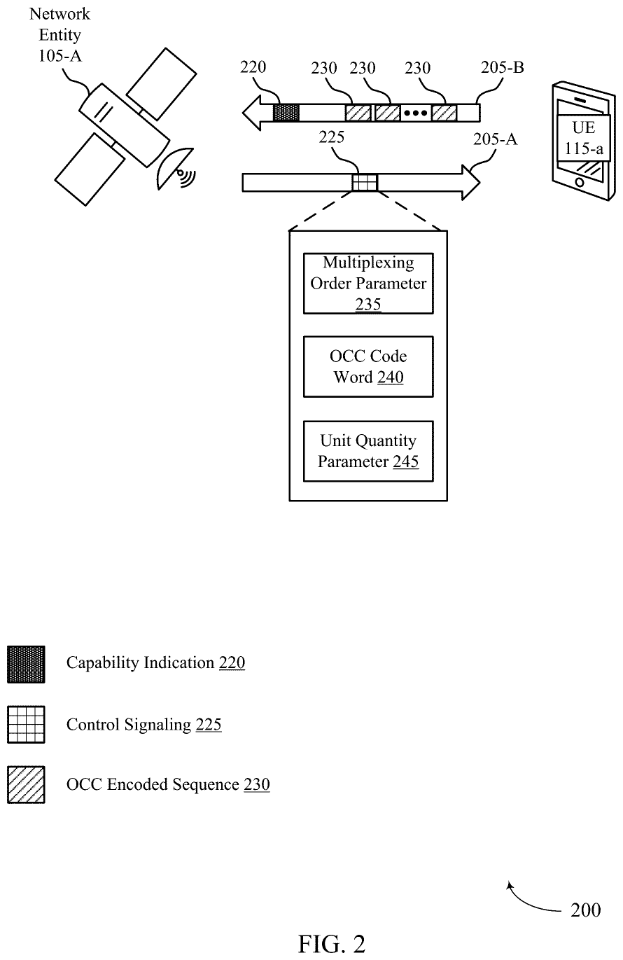

FIG. 2 shows an example of a wireless communications system 200 that supports orthogonal covering codes for clusters in non-terrestrial networks in accordance with one or more examples as disclosed herein.\

The wireless communications system 200 may include the network entity 105-a, which may be an example of one or more network entities discussed in relation to other figures. The wireless communications system 200 may include the UE 115-a, which may be an example of UEs discussed in relation to other figures. The network entity 105-a and UE 115-a may communicate via one or more downlink communication links 205-a and one or more uplink communication links 205-b. The UE 115-a and the network entity 105-a may operate in association with an NTN.

In wireless communications, including in NTNs, multiple access schemes may be used to multiplex communications of multiple UEs, thereby increasing capacity (e.g., where such increased capacity may refer to including a greater quantity of UE communications in a same quantity of time-frequency resources). However, multiplexing multiple UEs may create interference at network entities.

The use of OCCs may aid in mitigating interference. For example, the data transmitted by UEs may be cover coded across repetitions (e.g., in association with or through the use of transport block processing over multi-slots (TBoMS)) in an orthogonal manner using an OCC. In some examples, the nature of uplink transmissions (e.g., that include repetitions) may facilitate the use of OCC encoding with reduced losses or other advantages (e.g., in contrast to other encoding or multiple access schemes, such as code division multiple access (CDMA)).

The techniques described herein may involve the use of OCC encoding across clusters of resources. Such resources may include both time resources and frequency resources. For example, such resources may include OFDM resources. Such OFDM resources may be represented by a time-frequency grid with symbol divisions in time and sub-carriers (SCs) in frequency.

Frequency resources may be allocated in physical resource blocks (PRBs). In some examples, each PRB may include a quantity of sub-carriers represented by N_{scperprb}. In some examples, a quantity of PRBs, represented by N_{PRB} may be allocated to the same UE.

Time resources may be allocated in slots. In some examples, each slot may include a quantity of symbols (e.g., OFDM symbols), represented by N_{symbsperslot}. A quantity of slots, represented by Nₛₗₒₜₛ, may be allocated to the same UE.

In some examples involving TBoMS for uplink, a quantity of repetitions, represented by Nᵣₑₚ, may be available for an entire transmission. Thus, a total quantity of OFDM symbols allocated to a UE, represented by N_{TOTSYMS}, may be given by N_{TOTSYMS}=NᵣₑₚNₛₗₒₜₛN_{symsperslot}. Such symbols may be divided into clusters, which may be a collection of units (e.g., which may be bits, symbols, resource elements, mini-slots, slots, or any combination thereof) that are grouped together. For example, a cluster of symbols may include a quantity of symbols, represented by N_{symspercluster}. Thus, a total quantity of clusters N_{clusters} may be given by N_{clusters}=N_{TOTSYMS}/N_{symspercluster}. Similarly, a total quantity of symbols may be represented by N_{TOTSYMS}=N_{clusters}N_{symspercluster}.

In OCC multiplexing scenarios, a sequence (e.g., a bit sequence) may be spread into a quantity of clusters or spread sequences, where the quantity may be represented by M and may be referred to as a multiplexing order or OCC multiplexing order. For example, if the multiplexing order M=2, then the spreading may create 2 copies or instances of the sequence that are spread into a cluster. In some examples, the multiplexing order may correspond to a quantity of UEs whose signaling is to be multiplexed. For example, if four UEs are participating in the multiplexing scheme, the multiplexing order M may be equal to 4 and a respective bit sequence from each UE may be spread into four clusters. Such spread clusters for each UE may be encoded by the respective UEs using respective OCC code words (e.g., that may be different for each UE). Such encoding may generate encoded, spread clusters for a first UE that are orthogonal to other encoded, spread clusters associated with other UEs that are being multiplexed with the first UE. Thus, OCC approaches across clusters may aid in simplifying and standardizing communications protocols and configurations, as well as increasing communications quality, reliability, and capacity while reducing communications latency.

For example, the UE 115-a may transmit the capability indication 220. The capability indication 220 may indicate that the UE 115-a is capable of supporting the use of OCC multiplexing for operation in wireless communications networks, such as in connection with an NTN with which the network entity 105-a is associated. In some examples, the capability indication 220 may indicate one or more phase coherence capabilities or considerations of the UE 115-a.

In response, the network entity 105-a may transmit the control signaling 225. The control signaling 225 may include one or more parameters, values, indications, or any combination thereof that may aid the UE 115-a in performing OCC multiplexing.

For example, the control signaling 225 may include the multiplexing order parameter 235, the OCC code word 240, and the unit quantity parameter 245. The multiplexing order parameter 235 indicate a quantity of instances that are to be used in applying the OCC code word 240 to one or more sequences that are to be encoded and transmitted by the UE 115-a. Additionally, or alternatively, the multiplexing order parameter 235 may indicate a quantity of UEs (e.g., including the UE 115-a) whose signaling is to be multiplexed for transmission to the network entity 105-a. Further, the network entity 105-a may select, determine, or calculate the multiplexing order parameter 235 based on the one or more phase coherence capabilities or considerations of the UE 115-a.

The OCC code word 240 may be included in or may be associated with an orthogonal matrix (e.g., the OCC code word 240 may be a row or column of an orthogonal matrix, and the control signaling 225 indicates the OCC code word 240 from the matrix), whereby application of different OCC code words 240 to different sequences of different UEs may result in different encoded OCC sequences that are orthogonal to each other and are thereby capable of being decoded by the network entity 105-a (e.g., even though such encoded sequences may be transmitted in the same or overlapping time-frequency resources). The unit quantity parameter 245 may indicate a quantity of units (e.g., bits, symbols, resource elements, mini-slots, slots, or any combination thereof) that are spread into clusters of such units. For example, the unit quantity parameter 245 may correspond with or may be a parameter such as N_{symspercluster} that indicates a quantity of symbols per cluster, and the OCC code word is applied to a bit sequence to generate the OCC encoded sequence 230 for communication via a cluster (e.g., over a cluster). In an example of cluster-wise OCC with each cluster being 2 slots and an OCC factor being 2, after OCC, a cluster may be spread into 2 clusters (e.g., 4 slots). Such coordination of parameters (e.g., the multiplexing order parameter 235, the OCC code word 240, and the unit quantity parameter 245) across control signaling to different UEs that are to transmit signaling that is to be multiplexed together may aid in coordinating operations such that the multiplexing of multiple UEs is effective.

In response to receiving the control signaling 225, the UE 115-a may transmit the OCC encoded sequence 230 or multiple such OCC encoded sequences 230 to the network entity 105-a. Such OCC encoded sequences 230 may also be referred to as OCC encoded clusters. Similarly, other UEs may also transmit their own OCC encoded sequences 230 to the network entity 105-a that may overlap with those OCC encoded sequences 230 transmitted by the UE 115-a. However, these other UEs may have encoded their respective OCC encoded sequences 230 using different OCC code words 240 but with the same multiplexing order parameter 235 and unit quantity parameter 245, such that the OCC encoded sequences 230 of the other UEs may be of the same length (e.g., applying the respective OCC code words 240 to the same quantity of instances of unencoded sequences or clusters) and composition (e.g., where each OCC encoded sequence 230 or cluster includes a same quantity of units (e.g., bits, symbols, resource elements, mini-slots, slots, or any combination thereof)). In this way, the multiplexed OCC encoded sequences 230 from the UE 115-a and the other UEs may correspond and the OCC multiplexing may be effective.

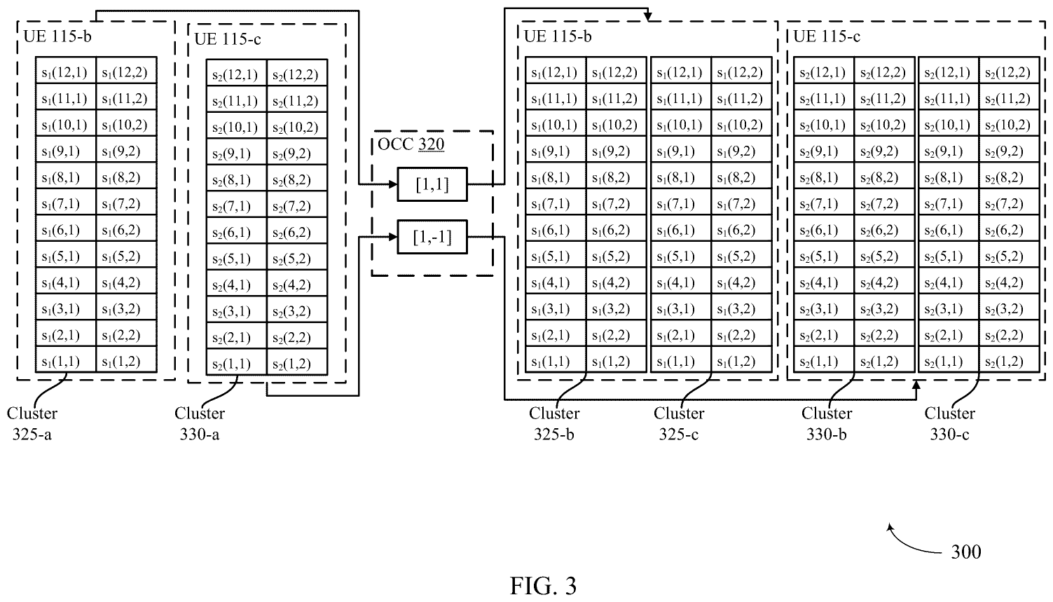

FIG. 3 shows an example of a multiplexing scheme 300 that supports orthogonal covering codes for clusters in non-terrestrial networks in accordance with one or more examples as disclosed herein.

The multiplexing scheme 300 depicts an example of two UEs (UE 115-b and UE 115-c) engaging in multiplexing using OCC over clusters 325 (e.g., associated with the UE 115-b) and clusters 330 (e.g., associated with the UE 115-c). In such an arrangement, which may be referred to as cluster-wise OCC, OCC code words (e.g., such as those included in the OCC 320) may be applied across groups of symbols, which may be referred to as clusters, such as clusters 325 and clusters 330. The clusters 325 and the clusters 330, in this example, are made up of various resource elements, designated by sᵢ(k, t), where i corresponds to a UE (e.g., a value of “1” may correspond to first UE, such as the UE 115-b, and a value of “2” may correspond to a second UE, such as the UE 115-c), k corresponds to a frequency resource for the UE i, and t corresponds to a time resource for the UE i.

In some examples, the application of the OCC 320 may be applied in different patterns. For example, as shown in FIG. 3, the clusters may be consecutive (e.g., cluster 325-a may be spread into cluster 325-b and cluster 325-c which may be consecutive clusters). However, in some examples, time resources allocated for the clusters may instead be non-consecutive (e.g., the cluster 325-a may be spread into cluster 325-b and cluster 325-c, which may be separated by other signaling, or a gap (e.g., a measurement gap).

In some examples, a spreading factor or multiplexing order M may indicate or correspond with a quantity of UEs whose signaling is to be multiplexed with OCC. For example, as shown in FIG. 3, M=2. As such, each cluster from each of the two UEs (UE 115-b and UE 115-c) is spread into two clusters, as cluster 325-a is spread into cluster 325-b and 325-c, and cluster 330-a is spread into cluster 330-b and 330-c. Thus, the spreading factor of 2 corresponds with the quantity of UEs.

In some examples, a sequence may include one or more elements (e.g., clusters, resource elements, bits, symbols, mini-slots, slots, or other divisions of time resources, frequency resources, or both), and a cluster may include one or more sequences. Such sequences may be a modulation sequence or a bit sequence. For example, a sequence associated with the UE 115-b may include one or more portions of the cluster 325-a (e.g., a column, row, or other division of a cluster), such as the resource elements s₁(1,1) through s₁(12,1) or the resource elements s₁(1,1) through s₁(12,1). Similarly, a sequence associated with the UE 115-c may include one or more portions of the cluster 330-a (e.g., a column, row, or other division of a cluster), such as the resource elements s₂(1,1) through s₂(12,1) or the resource elements s₂(1,1) through s₂(12,1). The clusters, the sequences, or both, may include one or more subdivisions or units, such as resource elements, bits, symbols, mini-slots, slots, or other divisions of time resources, frequency resources, or both. Each cluster, sequence, or both may include a quantity of units. A network entity may indicate to the UE 115-b and the UE 115-c the quantity of such units that are to be included in clusters, sequences, or both, so that such quantities are consistent across the UEs whose signaling is to be OCC multiplexed.

Such sequences may be processed through the OCC 320 (e.g., by applying an OCC code word associated with the OCC to one or more sequences, such as by multiplying one or more portions or elements of the code word with one or more sequences or portions of sequences) to produce an OCC encoded sequence. For example, the sequence of s₁(1,1) through s₁(12,1) and the sequence of s₁(1,2) through s₁(12,2) included in cluster 325-b may be OCC encoded sequences resulting from an application of the code word of [1,1] to the sequence of s₁(1,1) through s₁(12,1) and the sequence of s₁(1,2) through s₁(12,2) included in cluster 325-a. Similarly, the sequence of s₁(1,1) through s₁(12,1) and the sequence of s₁(1,2) through s₁(12,2) included in cluster 325-c, may also be OCC encoded sequences resulting from the application of the code word of [1,1] to the sequence of s₁(1,1) through s₁(12,1) and the sequence of s₁(1,2) through s₁(12,2) included in cluster 325-a. Similarly, the sequence s₂(1,1) through s₂(12,1) and the sequence of s₂(1,2) through s₂(12,2) included in cluster 330-b, and the sequence s₂(1,1) through s₂(12,1) and the sequence of s₂(1,2) through s₂(12,2) included in cluster 330-c may also be OCC encoded sequences, resulting from an application of the code word [1, −1] from the OCC 320 to the cluster 330-a.

After such OCC code sequences for the UE 115-b and the UE 115-c are generated, the UE 115-b and the UE 115-c may transmit their respective clusters (that include their respective OCC encoded sequences) at the same time and frequency resources (or at least partially overlapping time and frequency resources). For example, the UE 115-b may transmit the first column (e.g., OCC encoded sequence) of cluster 325-b at the same time and frequency resources (e.g., in a same symbol period) that the UE 115-c transmits the first column (e.g., being an OCC encoded sequence) of cluster 330-b. Similarly, the UE 115-b may transmit each successive column (each of which may be an OCC encoded sequence) of the cluster 325-b and the cluster 325-c in the same time and frequency resources in which the UE 115-c may transmit successive columns (each of which may also be an OCC encoded sequence) of the cluster 330-b and cluster 330-c (e.g., in the next 3 symbol periods, which may be consecutive or may have one or more intervening symbol periods). In other words, a first set of OCC encoded sequences corresponding to the four columns of clusters 325-b and 325-c may be respectively transmitted over 4 symbol periods, and a second set of OCC encoded sequences corresponding to the four columns of clusters 330-b and 330-c may be respectively transmitted over those same 4 symbol periods (and within the same frequency band).

Such an OCC code sequence associated with the UE 115-b may include the cluster 325-b and the cluster 325-c, and an OCC encoded sequence associated with the UE 115-c may include the cluster 330-b and the cluster 330-c.

The OCC encoded sequences may be generated by the application of the OCC 320 or an OCC code word of the OCC 320 to clusters 325-a and 325-b, respectively. For example, the OCC code word of [1, −1] may applied to the sequences (e.g., columns) of the cluster 330-a in accordance with the spreading factor of multiplexing order M, which is two in this example. In other words, the first element of the code word (e.g., “1”) may be applied to the two columns of cluster 330-a to generate two OCC encoded sequences included in the first two columns of cluster 330-b. Additionally, the second element of the code word (e.g., “−1”) may also be applied to the two columns of cluster 330-a to generate two OCC encoded sequences included in the first two columns of cluster 330-c. In some examples, such elements of the OCC code word may represent one or more operations to be performed, such as bit flip operations, phase shift operations, negation operations, one or more other operations, or any combination thereof.

Further, a quantity of OCC encoded sequences, clusters, or both, may correspond to the multiplexing order parameter. For example, as shown in FIG. 3, the UE 115-b produces the cluster 325-b and the cluster 325-c, which is a quantity of two clusters, by OCC encoding the first cluster 325-a. Similarly, the UE 115-c produces the cluster 330-b and the cluster 330-c, which is also a quantity of two clusters, by OCC encoding the second cluster 330-a. Thus, a UE may apply OCC encoding to spread a first quantity of sequences to a second quantity of OCC encoded sequence in accordance with the multiplexing order parameter indicated in control signaling received from a network entity. This multiplexing order parameter may also correspond to a quantity of UEs whose signaling is to be multiplexed into the same time/frequency resources.

As described herein, in some examples, each slot may include a quantity of symbols (e.g., OFDM symbols), represented by N_{symbsperslot}. A quantity of slots, represented by Nₛₗₒₜₛ, may be allocated to the same UE. In some examples, a quantity of repetitions, represented by Nᵣₑₚ, may be available for an entire transmission. Thus, a total quantity of OFDM symbols allocated to a UE, represented by N_{TOTSYMS}, may be given by N_{TOTSYMS}=Nᵣₑₚ Nₛₗₒₜₛ N_{symsperslot}. Such symbols may be divided into clusters, which may be a collection of units (e.g., which may be bits, symbols, resource elements, mini-slots, slots, or any combination thereof) that are grouped together. For example, a cluster of symbols may include a quantity of symbols, represented by N_{symspercluster}. Thus, a total quantity of clusters N_{clusters} may be given by N_{clusters}=N_{TOTSYMS}/N_{symspercluster}. Similarly, a total quantity of symbols may be represented by N_{TOTSYMS}=N_{clusters} N_{symspercluster}.

In some examples, for OCC approaches to make efficient use of resources, the spreading factor or multiplexing order M may be a factor of N_{clusters}. One example of such a scheme is shown in Equation 1 below. As a result of Equation 12, where N_{clusters}=12, a spreading factor or multiplexing order expressed as M=2,3,4,6,12 may be supported. By employing such a configuration, wasted resources may be reduced or eliminated. However, other values of M may also be supported, but may result in some wasted resources. Further, in some examples, higher values of M (e.g., those above a threshold) may result in corresponding higher coherence considerations. As such, in some examples, a value of M may be selected that may satisfy such a threshold (e.g., may be less than the threshold or may be less than or equal to the threshold) to reduce or eliminate such considerations related to coherence associated with higher values of M. Though these examples discussed are in relation to clusters of symbols, such clusters may also be clusters of other divisions of communications resources, including bits, symbols, mini-slots, slots, other divisions of communications resources (e.g., including time-domain divisions, frequency-domain divisions, or any combination thereof), or any combination thereof.

$${N}_{c lusters} = \frac{{N}_{T O T SYMS}}{{N}_{s y m s p e r c l u s t e r}} = \frac{{N}_{r e p} {N}_{s l o t s} {N}_{s y m s p e r s l o t}}{{N}_{s ymspercluster}} = \frac{4 * 1 * 12}{4} = 12 \qquad ( 1 )$$

In some examples, the use of the OCC 320 may be applied to different types of signals, including shared channel signaling, control channel signaling, reference signaling, one or more other types of signaling performed in wireless communications, or any combination thereof.

In some examples, the techniques described herein may be performed in connection with one or more repetitions of one or more sequences, such as in techniques involving TBoMS. In some examples, the OCC 320 may be included in or may be associated with an orthogonal matrix. In some examples, such an orthogonal matrix may include or be a Hadamard matrix, a discrete Fourier transform (DFT) matrix, one or more orthogonal matrices, or any combination thereof. In some examples, an OCC code word used in connection with the OCC 320 may be a row or column of such an orthogonal matrix. In some examples, a transport block size or quantity of information bits may be modified based on the spreading factor or multiplexing order M.

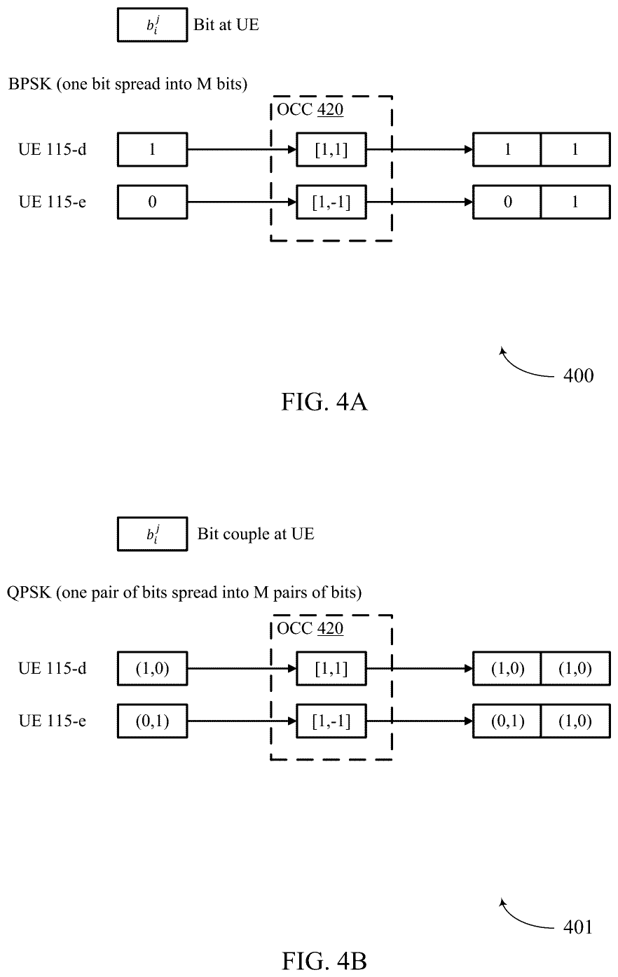

FIGS. 4A and 4B show examples of a multiplexing scheme 400 and a multiplexing scheme 401 that support orthogonal covering codes for clusters in non-terrestrial networks in accordance with one or more examples as disclosed herein.

FIG. 4A may depict an example of OCC multiplexing applied on a bit basis (e.g., as opposed to a cluster basis or other basis as described elsewhere herein). Such techniques may involve OCC encoded before modulation takes place. For example, the multiplexing scheme 400 may depict an example of an M-factor OCC multiplexing technique (e.g., in this case M=2) for the UE 115-d and the UE 115-e. For each UE, a bit (e.g., the bit bᵢ^{j}, where j indicates the particular bit and i indicates the UE that is to transmit that bit) that is to be transmitted is spread into M bits (e.g., 2 bits) and the spread bits corresponding to each UE are then orthogonal to the bits of the other UE once the bits have been encoded using code words of the OCC 420. For example, the bits 1 and 1 associated with the UE 115-d are therefore orthogonal to the bits 0 and 1 associated with the UE 115-e.

In some examples, the code words associated with the OCC 420 may include or indicate one or more bit flip operations (e.g., as opposed to other techniques in which a negation operation is indicated). For example, the spread bits associated with the UE 115-e are 0 and 1, even though the original bit was a 0. This is in accordance with the code word [1, −1] that is applied to the 0 bit associated with the UE 115-e.

In some examples involving OCC multiplexing on a bit-wise basis, the symbol modulation used may be binary phase shift keying (BPSK) or quadrature phase shift keying (QPSK). For example, in FIG. 4A, BPSK is used. Further, in some examples, a spreading sequence may include scalings of +1, −1, or both. For example, the spreading of the bits may be performed with either no phase shift or a phase shift of 180 degrees, and a “1” in an orthogonal matrix or OCC code word may correspond with a phase shift of zero degrees and a “−1” in an orthogonal matrix or OCC code word may correspond with a phase shift of 180 degrees. Other values, phase shifts, or both, may be employed (e.g., in association with different types of sequences or matrices). One such example of a spreading sequence may be a Hadamard sequence. In some examples, the use of bit-wise OCC may also be applicable to other OCC configurations (e.g., cluster-wise OCC, frequency domain-based OCC, and time domain-based OCC).\

In some examples, the bit that to which a codeword of the OCC 420 is to be applied may be considered a sequence (e.g., of one or more bits) and the bits produced as a result of the application of the code word may be considered OCC encoded sequences (e.g., of one or more bits). For example, the UE 115-d may apply the OCC codeword of [1,1] to the bit sequence “1” and the UE 115-e may apply the OCC codeword of [1, −1] to the bit sequence “1”. The UE 115-d may therefore generate two bit sequences of “1” and “1” in accordance with the OCC codeword and a multiplexing order parameter and the UE 115-e may therefore generate two bit sequences of “0” and “1” (the second having been subjected to a bit-flipping operation as indicated in the OCC codeword) in accordance with the OCC codeword and the multiplexing order parameter.

The UE 115-d and the UE 115-e may then transmit respective bit sequences (e.g., which may be OCC encoded sequences) in the same time resources, frequency resources, or both (or in at least partially overlapping time resources, frequency resources, or both). For example, the UE 115-d may transmit the resulting “1” bit in the same resources that the UE 115-e transmits the resulting “0” bit, and the UE 115-d may transmit the following “1” bit in the same resources that the UE 115-e transmits the following “1” bit, and such transmitted sequences may therefore be orthogonal and decodable by a wireless device (e.g., a network entity) receiving such transmissions.

FIG. 4B depicts an example of OCC multiplexing applied on a bit-pair basis (e.g., that may also be referred to as a bit-couple basis). In some examples, a bit pair may be a pair of bits that are to be transmitted by a wireless device that are also to be modulated together as a single unit. One such example that may modulate bit pairs may include quadrature phase shift keying. Such techniques may involve OCC encoded before modulation takes place.

The multiplexing scheme 401 may depict an example of an M-factor OCC multiplexing technique (e.g., in this case M=2) for the UE 115-d and the UE 115-e. For each UE, a bit pair (e.g., the bit pairᵢ^{j}, where j indicates a bit pair and i indicates the UE that is to transmit that bit pair) that is to be transmitted is spread into M bit pairs (e.g., 2 bit pairs) and the spread bit pairs corresponding to each UE are then orthogonal to the bits of the other UE once the bits have been encoded using code words of the OCC 420. For example, the bit pairs of (1,0) and (1,0) associated with the UE 115-d are therefore orthogonal to the bit pairs of (0,1) and (1,0), associated with the UE 115-e.

In some examples, the code words associated with the OCC 420 may include or indicate one or more bit flip operations (e.g., as opposed to other techniques in which a negation operation is indicated). For example, the spread bit pairs associated with the UE 115-e are (0,1) and (1,0), even though the original bit pairs were (0,1). This is in accordance with the code word [1, −1] that is applied to the (0,1) bit pair associated with the UE 115-e. For example, as the first element of the code word is “1”, this may indicate that no bit-flip operation is to be performed to a first instance of the spread bit pairs. As such, the corresponding bit pair in the output remains the same (0,1) as the input bit pair. Similarly, as the second element of the code word is “−1”, this may indicate that a bit-flip operation is to be performed to the second instance of the spread bit pairs, As such, the corresponding bit pair in the output is flipped from (0,1) to (1,0).

In some examples, such as the example depicted in FIG. 4B, QPSK modulation may be applied (e.g., due to use of bit pairs as opposed to individual bits).

In some examples, the bit pair that to which a codeword of the OCC 420 is to be applied may be considered a sequence (e.g., of one or more bit pairs) and the bit pairs produced as a result of the application of the code word may be considered OCC encoded sequences (e.g., of one or more bit pairs). For example, the UE 115-d may apply the OCC codeword of [1,1] to the bit pair sequence (1,0) and the UE 115-e may apply the OCC codeword of [1, −1] to the bit pair sequence (0,1). The UE 115-d may therefore generate two bit pair sequences of (1,0) and (1,0) in accordance with the OCC codeword and a multiplexing order parameter and the UE 115-e may therefore generate two bit pair sequences of (0,1) and (1,0) (the second having been subjected to a bit pair-flipping operation as indicated in the OCC codeword) in accordance with the OCC codeword and the multiplexing order parameter.

The UE 115-d and the UE 115-e may then transmit respective bit pair sequences (e.g., which may be OCC encoded sequences) in the same time resources, frequency resources, or both (or in at least partially overlapping time resources, frequency resources, or both). For example, the UE 115-d may transmit the resulting (1,0) bit pair in the same resources that the UE 115-e transmits the resulting (0,1) bit pair, and the UE 115-d may transmit the following (1,0) bit pair in the same resources that the UE 115-e transmits the following (1,0) bit pair, and such transmitted sequences may therefore be orthogonal and decodable by a wireless device (e.g., a network entity) receiving such transmissions.

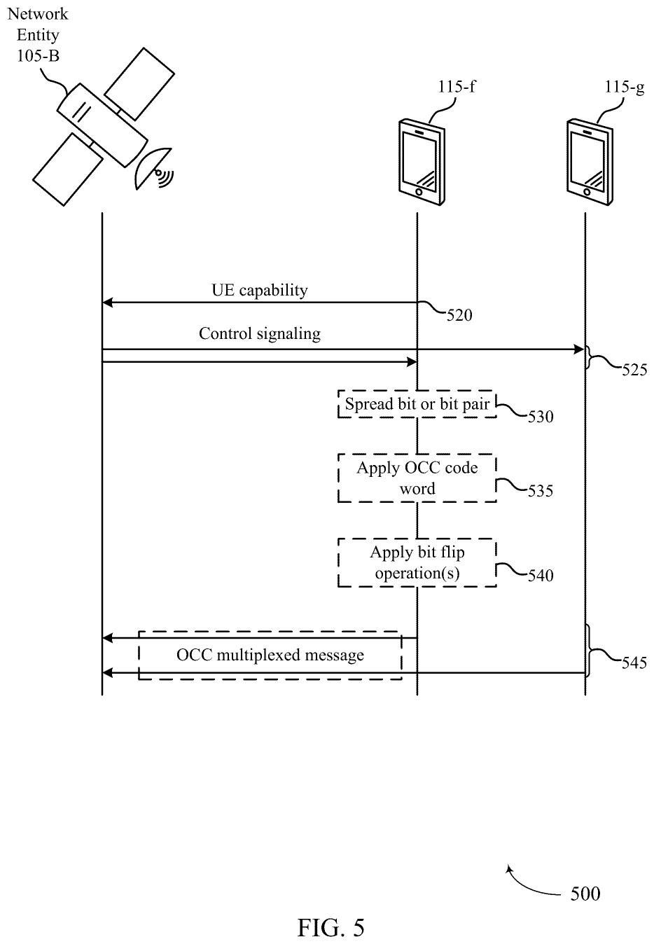

FIG. 5 shows an example of a process flow 500 that supports orthogonal covering codes for clusters in non-terrestrial networks in accordance with one or more examples as disclosed herein.

The process flow 500 may implement various aspects of the present disclosure described herein. The elements described in the process flow 500 (e.g., UE 115-f and network entity 105-b) may be examples of similarly named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or element of the process flow 500 or by entities or elements that are not depicted in the process flow, or any combination thereof.

At 520, the UE 115-f may transmit an indication of a capability of the UE to support OCC multiplexing. In some examples, the capability of the UE to support OCC multiplexing is based on one or more phase coherence capabilities of the UE.

At 525, the UE 115-f may receive, based on the indication, control signaling indicating a multiplexing order parameter, an OCC code word that the UE 115-f is to apply for OCC multiplexing, and a quantity of units comprised in each cluster in which the UE is to apply OCC multiplexing. In some examples, the multiplexing order parameter is based on the one or more phase coherence capabilities of the UE. In some examples, a unit may include a bit, a symbol, a resource element, a mini-slot, or a slot. In some examples, a cluster of the plurality of clusters may include a plurality of symbols, a plurality of resource elements, a plurality of mini-slots, or a plurality of slots. In some examples, the multiplexing order parameter is a factor of a quantity of the plurality of clusters comprised in time-frequency resources allocated to the UE for communication of the plurality of OCC encoded sequences over the plurality of clusters.

Further, the network entity 105-b may also configure the UE 115-g to transmit additional OCC encoded signaling that is to be transmitted in the same time resources, frequency resources, or both (or at least partially overlapping time resources, frequency resources, or both) as those in which OCC encoded signaling is to be transmitted by the UE 115-f. For example, the network entity 105-b may transmit control signaling to the UE 115-g that may include the multiplexing order parameter (e.g., the same as the multiplexing order parameter transmitted to the UE 115-f), an OCC code word that the UE 115-g is to apply for OCC multiplexing (that may be different than the OCC code word indicated to the UE but that may be related to the OCC code word transmitted to the UE 115-f), and a quantity of units comprised in each cluster in which the UE is to apply OCC multiplexing (e.g., the same as the multiplexing order parameter transmitted to the UE 115-f). In some examples, the OCC code word transmitted to the UE 115-g may be an OCC code word that is associated with a same orthogonal matrix with which the OCC word transmitted to the UE 115-f is associated. For example, such code words may be different rows or different columns of a same orthogonal matrix. In this way, the orthogonality of the different transmissions from the UE 115-f and the UE 115-g may be achieved.

At 530, the UE 115-f may spread a first bit or a first bit pair of a first bit sequence of the plurality of sequences by the OCC code word to generate a first OCC encoded sequence of the plurality of OCC encoded sequences.

At 535, the UE 115-f may apply the OCC code word to the plurality of sequences to generate the plurality of OCC encoded sequences and a quantity of the plurality of OCC encoded sequences corresponds to the multiplexing order parameter. In some examples, the OCC code word may be associated with an orthogonal matrix.

At 540, the UE 115-f may apply one or more bit flip operations to the first bit or the first bit pair of the plurality of sequences based on the OCC code word and the first bit or the first bit pair in the plurality of sequences is modulated via binary phase shift keying or quadrature phase shift keying. In some examples, at least one element of the OCC codeword may indicate a phase shift value corresponding to zero degrees or one-hundred eighty degrees.

At 545, the UE 115-f may transmit, over a plurality of clusters, an OCC multiplexed message that may include a plurality of OCC encoded sequences, the plurality of OCC encoded sequences that may include a plurality of sequences encoded by the OCC code word in accordance with the multiplexing order parameter and the quantity of units. In some examples, to transmit the plurality of OCC encoded sequences, the UE may transmit shared channel signaling, control channel signaling, reference signaling, or any combination thereof, that is generated based on the plurality of OCC encoded sequences. In some examples, the plurality of clusters are consecutive in time or are non-consecutive in time.

Further, another UE, such as the UE 115-g, may transmit another OCC multiplexed message that may overlap with the OCC multiplexed message that the UE 115-f transmits. The OCC multiplexed message transmitted by the UE 115-f may be multiplexed with and may also be orthogonal to the OCC multiplexed message transmitted by the UE 115-g. Further, these OCC multiplexed messages may be transmitted in the same time resources, frequency resources, or both (or in at least partially overlapping time resources, frequency resources, or both).

Similarly, the network entity 105-b may receive both of the OCC multiplexed messages from the UE 115-f and the UE 115-g. The network entity 105-b may be able to separate, discern, identify, or obtain the OCC multiplexed messages as separate messages due to the orthogonal relationship between the OCC multiplexed messages, the common parameters (e.g., the multiplexing order and the quantity of units of each cluster) and related parameters (e.g., the OCC code words being associated with a same orthogonal matrix).

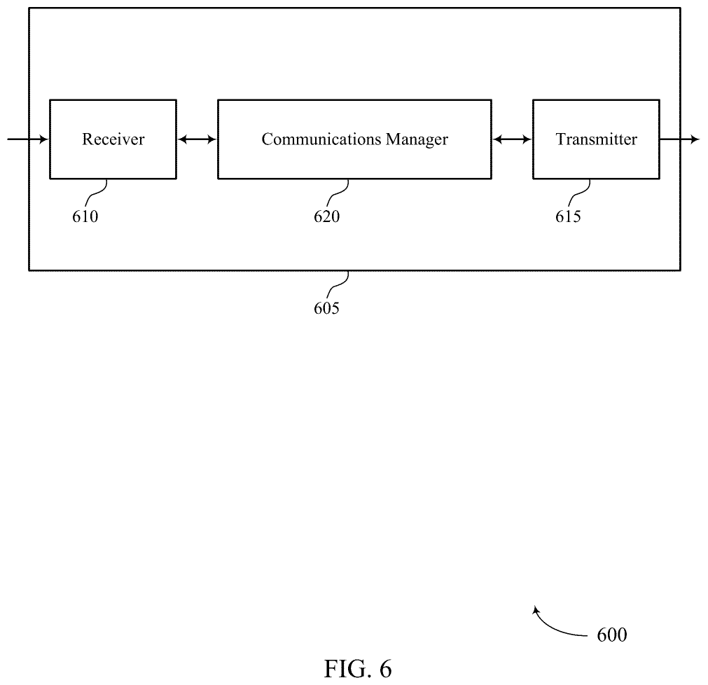

FIG. 6 shows a block diagram 600 of a device 605 that supports orthogonal covering codes for clusters in non-terrestrial networks in accordance with one or more examples as disclosed herein. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to orthogonal covering codes for clusters in non-terrestrial networks). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to orthogonal covering codes for clusters in non-terrestrial networks). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of orthogonal covering codes for clusters in non-terrestrial networks as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

Additionally, or alternatively, the communications manager 620 may support wireless communications in accordance with examples as disclosed herein. For example, the communications manager 620 is capable of, configured to, or operable to support a means for transmitting an indication of a capability of the UE to support OCC multiplexing. The communications manager 620 is capable of, configured to, or operable to support a means for receiving, based on the indication, control signaling indicating a multiplexing order parameter, an OCC code word that the UE is to apply for OCC multiplexing, and a quantity of units included in each cluster in which the UE is to apply OCC multiplexing. The communications manager 620 is capable of, configured to, or operable to support a means for transmitting, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing, reduced power consumption, more efficient utilization of communication resources, or any combination thereof.

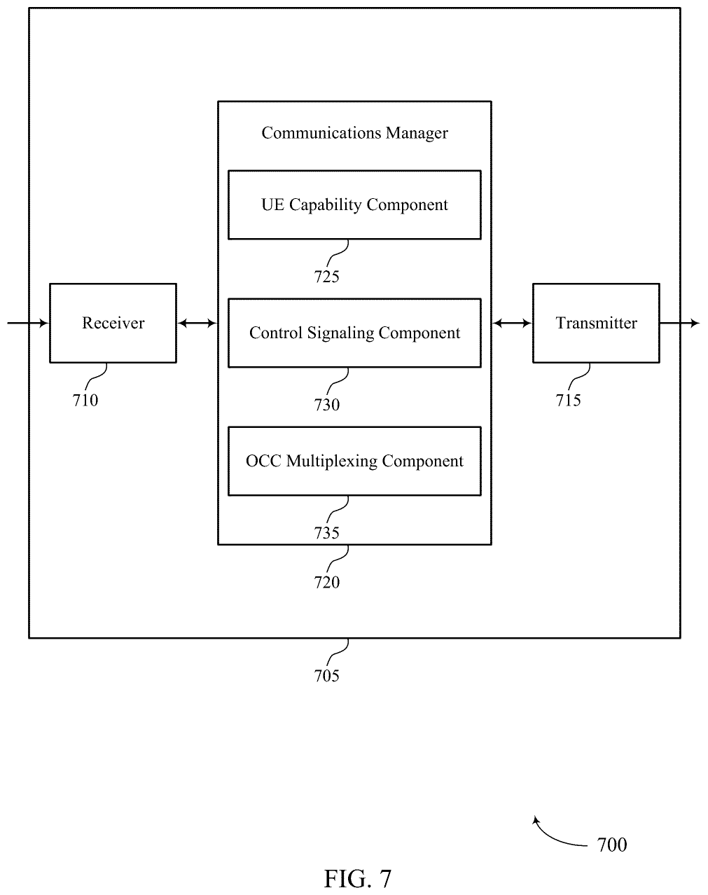

FIG. 7 shows a block diagram 700 of a device 705 that supports orthogonal covering codes for clusters in non-terrestrial networks in accordance with one or more examples as disclosed herein. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to orthogonal covering codes for clusters in non-terrestrial networks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to orthogonal covering codes for clusters in non-terrestrial networks). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of orthogonal covering codes for clusters in non-terrestrial networks as described herein. For example, the communications manager 720 may include a UE capability component 725, a control signaling component 730, an OCC multiplexing component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The UE capability component 725 is capable of, configured to, or operable to support a means for transmitting an indication of a capability of the UE to support OCC multiplexing. The control signaling component 730 is capable of, configured to, or operable to support a means for receiving, based on the indication, control signaling indicating a multiplexing order parameter, an OCC code word that the UE is to apply for OCC multiplexing, and a quantity of units included in each cluster in which the UE is to apply OCC multiplexing. The OCC multiplexing component 735 is capable of, configured to, or operable to support a means for transmitting, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

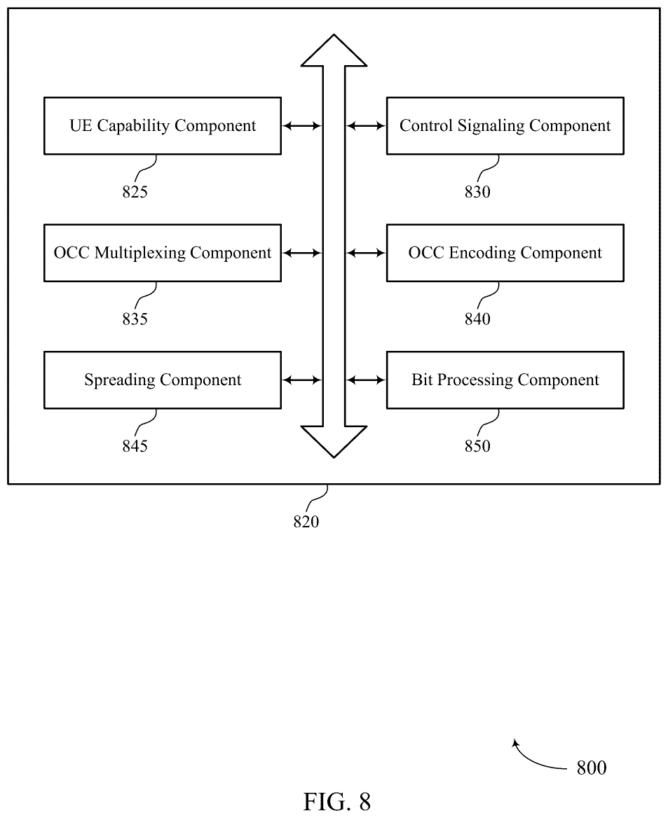

FIG. 8 shows a block diagram 800 of a communications manager 820 that supports orthogonal covering codes for clusters in non-terrestrial networks in accordance with one or more examples as disclosed herein. The communications manager 820 may be an example of aspects of a communications manager 620, a communications manager 720, or both, as described herein. The communications manager 820, or various components thereof, may be an example of means for performing various aspects of orthogonal covering codes for clusters in non-terrestrial networks as described herein. For example, the communications manager 820 may include a UE capability component 825, a control signaling component 830, an OCC multiplexing component 835, an OCC encoding component 840, a spreading component 845, a bit processing component 850, or any combination thereof. Each of these components, or components or subcomponents thereof (e.g., one or more processors, one or more memories), may communicate, directly or indirectly, with one another (e.g., via one or more buses).

Additionally, or alternatively, the communications manager 820 may support wireless communications in accordance with examples as disclosed herein. The UE capability component 825 is capable of, configured to, or operable to support a means for transmitting an indication of a capability of the UE to support OCC multiplexing. The control signaling component 830 is capable of, configured to, or operable to support a means for receiving, based on the indication, control signaling indicating a multiplexing order parameter, an OCC code word that the UE is to apply for OCC multiplexing, and a quantity of units included in each cluster in which the UE is to apply OCC multiplexing. The OCC multiplexing component 835 is capable of, configured to, or operable to support a means for transmitting, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

In some examples, the capability of the UE to support OCC multiplexing is based on one or more phase coherence capabilities of the UE. In some examples, the multiplexing order parameter is based on the one or more phase coherence capabilities of the UE.

In some examples, the OCC encoding component 840 is capable of, configured to, or operable to support a means for applying the OCC code word to the set of multiple sequences to generate the set of multiple OCC encoded sequences, where a quantity of the set of multiple OCC encoded sequences corresponds to the multiplexing order parameter.

In some examples, a unit includes a bit, a symbol, a resource element, a mini-slot, or a slot. In some examples, a cluster of the set of multiple clusters includes a set of multiple symbols, a set of multiple resource elements, a set of multiple mini-slots, or a set of multiple slots.

In some examples, a unit includes a bit, and the spreading component 845 is capable of, configured to, or operable to support a means for spreading a first bit or a first bit pair of a first bit sequence of the set of multiple sequences by the OCC code word to generate a first OCC encoded sequence of the set of multiple OCC encoded sequences.

In some examples, the bit processing component 850 is capable of, configured to, or operable to support a means for applying one or more bit flip operations to the first bit or the first bit pair of the set of multiple sequences based on the OCC code word, where the first bit or the first bit pair in the set of multiple sequences is modulated via binary phase shift keying or quadrature phase shift keying, and where at least one element of the OCC codeword indicates a phase shift value corresponding to zero degrees or one-hundred eighty degrees.

In some examples, the multiplexing order parameter is a factor of a quantity of the set of multiple clusters included in time-frequency resources allocated to the UE for communication of the set of multiple OCC encoded sequences over the set of multiple clusters.

In some examples, to support transmitting the set of multiple OCC encoded sequences, the OCC multiplexing component 835 is capable of, configured to, or operable to support a means for transmitting shared channel signaling, control channel signaling, reference signaling, or any combination thereof, that is generated based on the set of multiple OCC encoded sequences.

In some examples, the OCC code word is associated with an orthogonal matrix.

In some examples, the set of multiple clusters are consecutive in time or are non-consecutive in time.

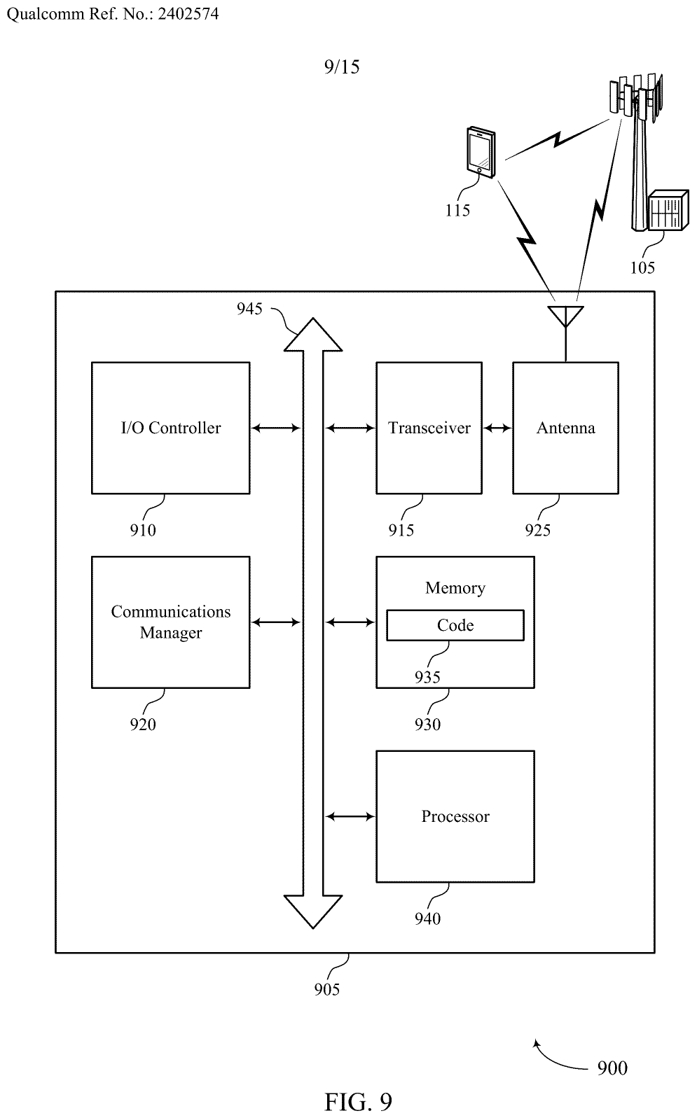

FIG. 9 shows a diagram of a system 900 including a device 905 that supports orthogonal covering codes for clusters in non-terrestrial networks in accordance with one or more examples as disclosed herein. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting orthogonal covering codes for clusters in non-terrestrial networks). For example, the device 905 or a component of the device 905 may include at least one processor 940 and at least one memory 930 coupled with or to the at least one processor 940, the at least one processor 940 and the at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

Additionally, or alternatively, the communications manager 920 may support wireless communications in accordance with examples as disclosed herein. For example, the communications manager 920 is capable of, configured to, or operable to support a means for transmitting an indication of a capability of the UE to support OCC multiplexing. The communications manager 920 is capable of, configured to, or operable to support a means for receiving, based on the indication, control signaling indicating a multiplexing order parameter, an OCC code word that the UE is to apply for OCC multiplexing, and a quantity of units included in each cluster in which the UE is to apply OCC multiplexing. The communications manager 920 is capable of, configured to, or operable to support a means for transmitting, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

By including or configuring the communications manager 920 in accordance with examples as described herein, the device 905 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 920 may be configured to perform various operations (e.g., receiving, monitoring, transmitting) using or otherwise in cooperation with the transceiver 915, the one or more antennas 925, or any combination thereof. For example, the communications manager 920 may be configured to receive or transmit messages or other signaling as described herein via the transceiver 915. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of orthogonal covering codes for clusters in non-terrestrial networks as described herein, or the at least one processor 940 and the at least one memory 930 may be otherwise configured to, individually or collectively, perform or support such operations.

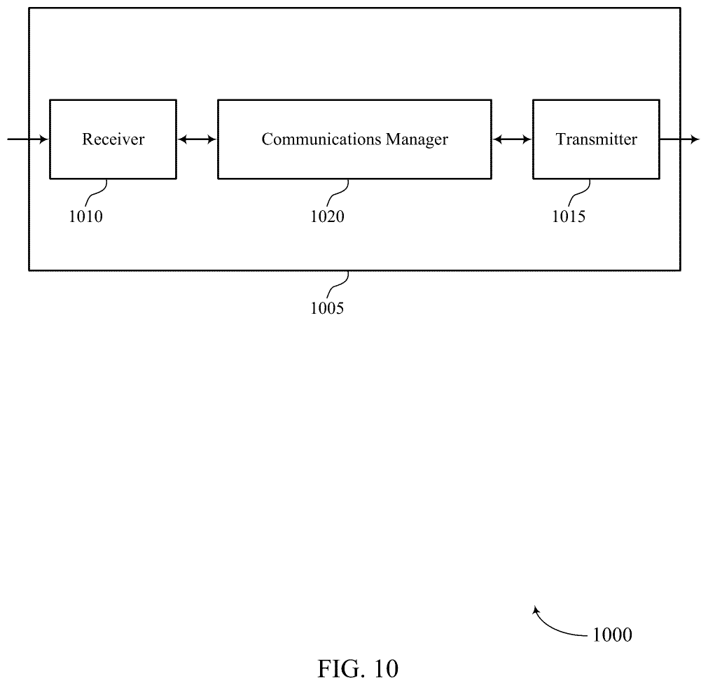

FIG. 10 shows a block diagram 1000 of a device 1005 that supports orthogonal covering codes for clusters in non-terrestrial networks in accordance with one or more examples as disclosed herein. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of orthogonal covering codes for clusters in non-terrestrial networks as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

Additionally, or alternatively, the communications manager 1020 may support wireless communications in accordance with examples as disclosed herein. For example, the communications manager 1020 is capable of, configured to, or operable to support a means for obtaining an indication of a capability of a UE to support OCC multiplexing. The communications manager 1020 is capable of, configured to, or operable to support a means for outputting, based on the indication, control signaling indicating a multiplexing order parameter, an OCC code word that the UE is to apply for OCC multiplexing, and a quantity of units included in each cluster in which the UE is to apply OCC multiplexing. The communications manager 1020 is capable of, configured to, or operable to support a means for obtaining, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for reduced processing, reduced power consumption, more efficient utilization of communication resources, or any combination thereof.

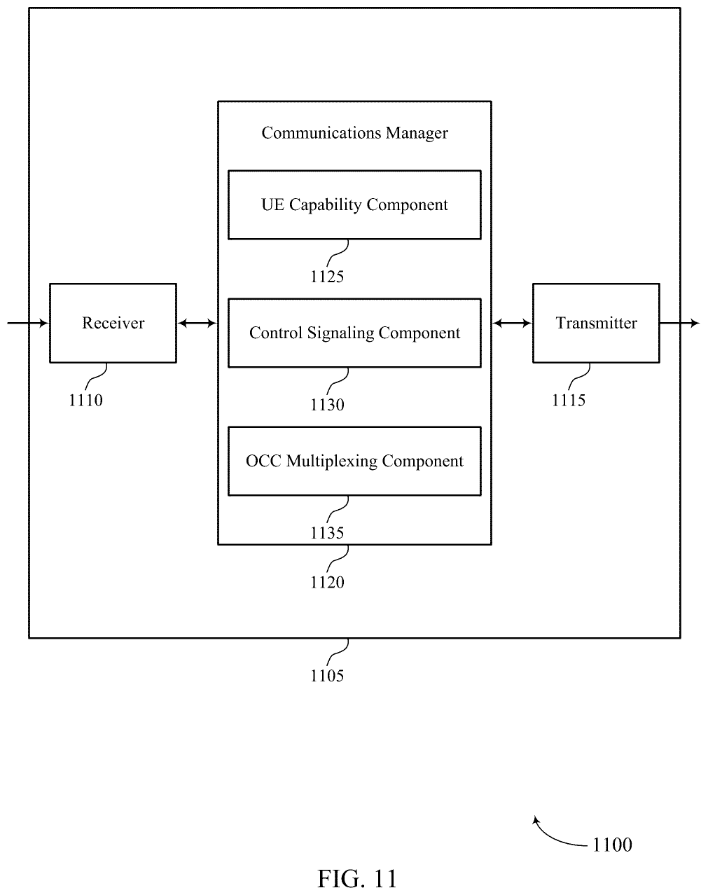

FIG. 11 shows a block diagram 1100 of a device 1105 that supports orthogonal covering codes for clusters in non-terrestrial networks in accordance with one or more examples as disclosed herein. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of orthogonal covering codes for clusters in non-terrestrial networks as described herein. For example, the communications manager 1120 may include a UE capability component 1125, a control signaling component 1130, an OCC multiplexing component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The UE capability component 1125 is capable of, configured to, or operable to support a means for obtaining an indication of a capability of a UE to support OCC multiplexing. The control signaling component 1130 is capable of, configured to, or operable to support a means for outputting, based on the indication, control signaling indicating a multiplexing order parameter, an OCC code word that the UE is to apply for OCC multiplexing, and a quantity of units included in each cluster in which the UE is to apply OCC multiplexing. The OCC multiplexing component 1135 is capable of, configured to, or operable to support a means for obtaining, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

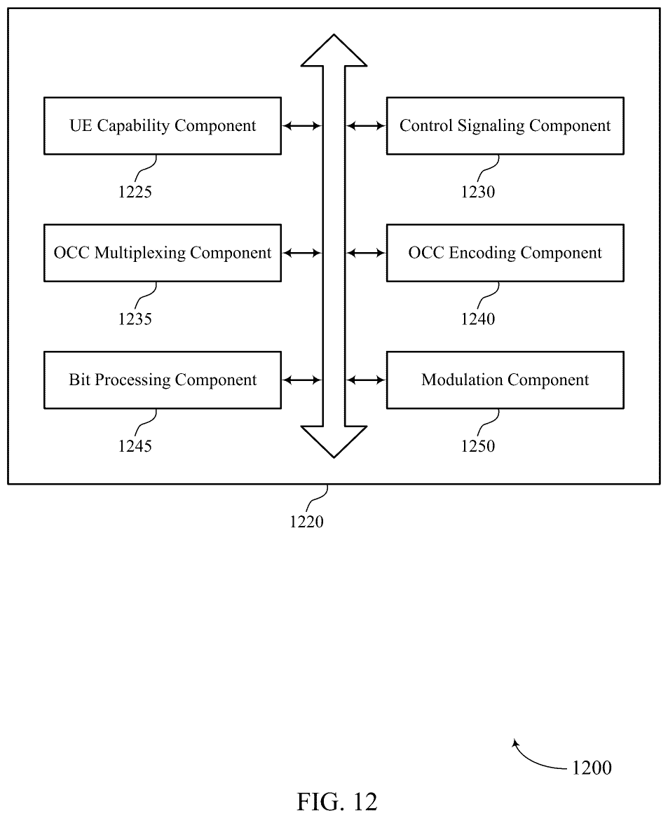

FIG. 12 shows a block diagram 1200 of a communications manager 1220 that supports orthogonal covering codes for clusters in non-terrestrial networks in accordance with one or more examples as disclosed herein. The communications manager 1220 may be an example of aspects of a communications manager 1020, a communications manager 1120, or both, as described herein. The communications manager 1220, or various components thereof, may be an example of means for performing various aspects of orthogonal covering codes for clusters in non-terrestrial networks as described herein. For example, the communications manager 1220 may include a UE capability component 1225, a control signaling component 1230, an OCC multiplexing component 1235, an OCC encoding component 1240, a bit processing component 1245, a modulation component 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1220 may support wireless communications in accordance with examples as disclosed herein. The UE capability component 1225 is capable of, configured to, or operable to support a means for obtaining an indication of a capability of a UE to support OCC multiplexing. The control signaling component 1230 is capable of, configured to, or operable to support a means for outputting, based on the indication, control signaling indicating a multiplexing order parameter, an OCC code word that the UE is to apply for OCC multiplexing, and a quantity of units included in each cluster in which the UE is to apply OCC multiplexing. The OCC multiplexing component 1235 is capable of, configured to, or operable to support a means for obtaining, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

In some examples, the indication of the capability of the UE to support OCC multiplexing is based on one or more phase coherence capabilities of the UE. In some examples, the multiplexing order parameter is based on the one or more phase coherence capabilities of the UE.

In some examples, a quantity of the set of multiple OCC encoded sequences corresponds to the multiplexing order parameter.

In some examples, a unit includes a bit, a symbol, a resource element, a mini-slot, or a slot. In some examples, a cluster of the set of multiple clusters includes a set of multiple symbols, a set of multiple resource elements, a set of multiple mini-slots, or a set of multiple slots.

In some examples, a unit includes a bit. In some examples, a first OCC encoded sequence of the set of multiple OCC encoded sequences is based on a first bit or a first bit pair of a first bit sequence of the set of multiple sequences being spread by the OCC code word.

In some examples, a first OCC encoded sequence of the set of multiple OCC encoded sequences is based on one or more bit flip operations being applied to the first bit or the first bit pair of the set of multiple sequences in accordance with the OCC code word. In some examples, the first bit or the first bit pair in the set of multiple sequences is modulated via binary phase shift keying or quadrature phase shift keying. In some examples, at least one element of the OCC codeword indicates a phase shift value corresponding to zero degrees or one-hundred eighty degrees.

In some examples, the multiplexing order parameter is a factor of a quantity of the set of multiple clusters included in time-frequency resources allocated to the UE for communication of the set of multiple OCC encoded sequences over the set of multiple clusters.

In some examples, the set of multiple OCC encoded sequences are included in shared channel signaling, control channel signaling, reference signaling, or any combination thereof.

In some examples, the OCC code word is associated with an orthogonal matrix.

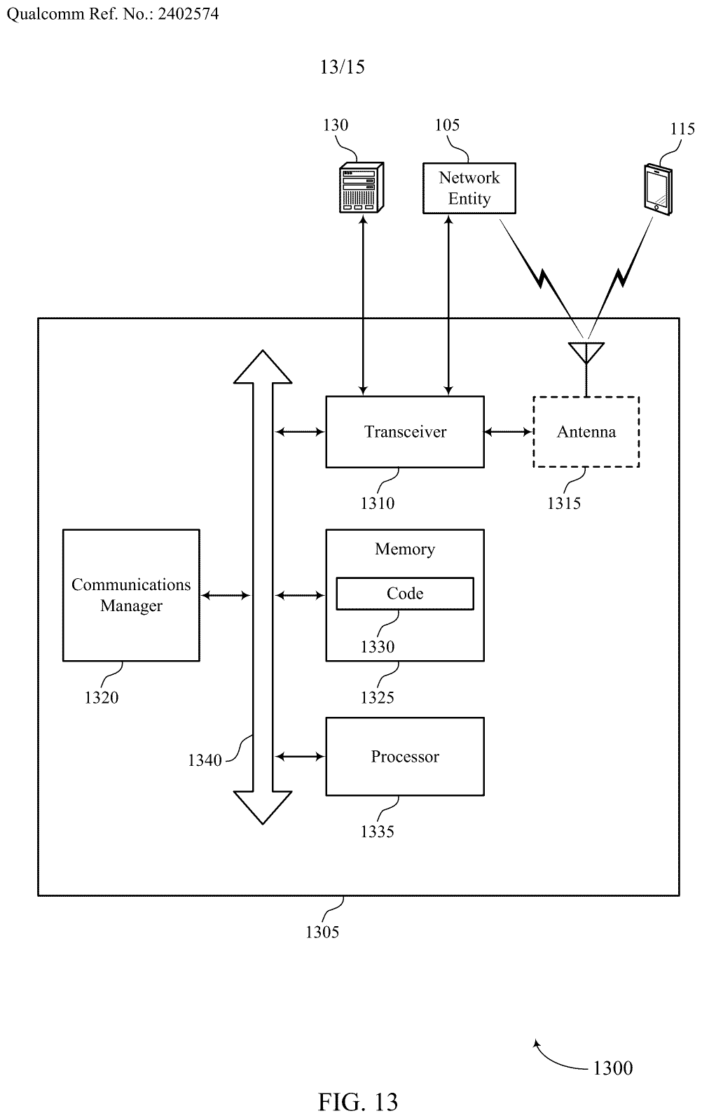

FIG. 13 shows a diagram of a system 1300 including a device 1305 that supports orthogonal covering codes for clusters in non-terrestrial networks in accordance with one or more examples as disclosed herein. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more central processing units (CPUs), one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting orthogonal covering codes for clusters in non-terrestrial networks). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105 and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

Additionally, or alternatively, the communications manager 1320 may support wireless communications in accordance with examples as disclosed herein. For example, the communications manager 1320 is capable of, configured to, or operable to support a means for obtaining an indication of a capability of a UE to support OCC multiplexing. The communications manager 1320 is capable of, configured to, or operable to support a means for outputting, based on the indication, control signaling indicating a multiplexing order parameter, an OCC code word that the UE is to apply for OCC multiplexing, and a quantity of units included in each cluster in which the UE is to apply OCC multiplexing. The communications manager 1320 is capable of, configured to, or operable to support a means for obtaining, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units.

By including or configuring the communications manager 1320 in accordance with examples as described herein, the device 1305 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. For example, the communications manager 1320 may be configured to receive or transmit messages or other signaling as described herein via the transceiver 1310. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of orthogonal covering codes for clusters in non-terrestrial networks as described herein, or the at least one processor 1335 and the at least one memory 1325 may be otherwise configured to, individually or collectively, perform or support such operations.

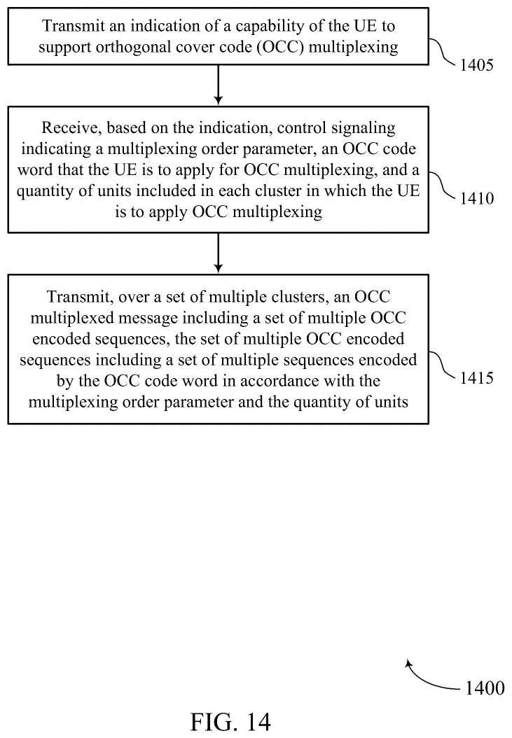

FIG. 14 shows a flowchart illustrating a method 1400 that supports orthogonal covering codes for clusters in non-terrestrial networks in accordance with one or more examples as disclosed herein. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting an indication of a capability of the UE to support OCC multiplexing. The operations of 1405 may be performed in accordance with examples as disclosed herein. In some examples, aspects of the operations of 1405 may be performed by a UE capability component 825 as described with reference to FIG. 8. Additionally, or alternatively, means for performing 1405 may, but not necessarily include, for example, antenna 925, transceiver 915, communications manager 920, memory 930 (including code 935), processor 940 and/or bus 945.

At 1410, the method may include receiving, based on the indication, control signaling indicating a multiplexing order parameter, an OCC code word that the UE is to apply for OCC multiplexing, and a quantity of units included in each cluster in which the UE is to apply OCC multiplexing. The operations of 1410 may be performed in accordance with examples as disclosed herein. In some examples, aspects of the operations of 1410 may be performed by a control signaling component 830 as described with reference to FIG. 8. Additionally, or alternatively, means for performing 1410 may, but not necessarily include, for example, antenna 925, transceiver 915, communications manager 920, memory 930 (including code 935), processor 940 and/or bus 945.

At 1415, the method may include transmitting, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units. The operations of 1415 may be performed in accordance with examples as disclosed herein. In some examples, aspects of the operations of 1415 may be performed by an OCC multiplexing component 835 as described with reference to FIG. 8. Additionally, or alternatively, means for performing 1415 may, but not necessarily include, for example, antenna 925, transceiver 915, communications manager 920, memory 930 (including code 935), processor 940 and/or bus 945.

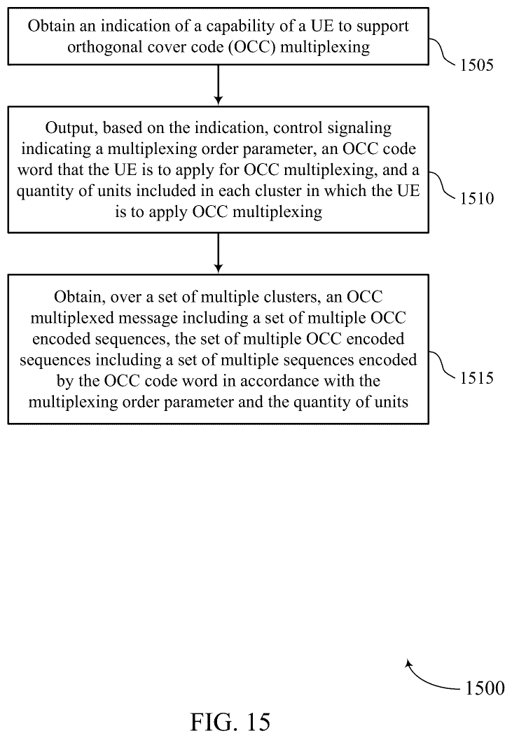

FIG. 15 shows a flowchart illustrating a method 1500 that supports orthogonal covering codes for clusters in non-terrestrial networks in accordance with one or more examples as disclosed herein. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include obtaining an indication of a capability of a UE to support OCC multiplexing. The operations of 1505 may be performed in accordance with examples as disclosed herein. In some examples, aspects of the operations of 1505 may be performed by a UE capability component 1225 as described with reference to FIG. 12. Additionally, or alternatively, means for performing 1505 may, but not necessarily include, for example, antenna 1315, transceiver 1310, communications manager 1320, memory 1325 (including code 1330), processor 1335 and/or bus 1340.

At 1510, the method may include outputting, based on the indication, control signaling indicating a multiplexing order parameter, an OCC code word that the UE is to apply for OCC multiplexing, and a quantity of units included in each cluster in which the UE is to apply OCC multiplexing. The operations of 1510 may be performed in accordance with examples as disclosed herein. In some examples, aspects of the operations of 1510 may be performed by a control signaling component 1230 as described with reference to FIG. 12. Additionally, or alternatively, means for performing 1505 may, but not necessarily include, for example, antenna 1315, transceiver 1310, communications manager 1320, memory 1325 (including code 1330), processor 1335 and/or bus 1340.

At 1515, the method may include obtaining, over a set of multiple clusters, an OCC multiplexed message including a set of multiple OCC encoded sequences, the set of multiple OCC encoded sequences including a set of multiple sequences encoded by the OCC code word in accordance with the multiplexing order parameter and the quantity of units. The operations of 1515 may be performed in accordance with examples as disclosed herein. In some examples, aspects of the operations of 1515 may be performed by an OCC multiplexing component 1235 as described with reference to FIG. 12. Additionally, or alternatively, means for performing 1505 may, but not necessarily include, for example, antenna 1315, transceiver 1310, communications manager 1320, memory 1325 (including code 1330), processor 1335 and/or bus 1340.

The following provides an overview of aspects of the present disclosure:

Aspect 1: A method for wireless communications at a UE, including: transmitting an indication of a capability of the UE to support OCC multiplexing, receiving, based at least in part on the indication, control signaling indicating a multiplexing order parameter, an OCC code word that the UE is to apply for OCC multiplexing, and a quantity of units comprised in each cluster in which the UE is to apply OCC multiplexing, and transmitting, over a plurality of clusters, an OCC multiplexed message including a plurality of OCC encoded sequences, the plurality of OCC encoded sequences including a plurality of sequences encoded by the OCC code word in accordance with the multiplexing order parameter and the quantity of units.

Aspect 2: The method of aspect 1, where the capability of the UE to support OCC multiplexing is based at least in part on one or more phase coherence capabilities of the UE.

Aspect 3: The method of any of aspects 1 through 2, further including: applying the OCC code word to the plurality of sequences to generate the plurality of OCC encoded sequences, where a quantity of the plurality of OCC encoded sequences corresponds to the multiplexing order parameter.

Aspect 4: The method of any of aspects 1 through 3, where a unit comprises a bit, a symbol, a resource element, a mini-slot, or a slot, and a cluster of the plurality of clusters comprises a plurality of symbols, a plurality of resource elements, a plurality of mini-slots, or a plurality of slots.

Aspect 5: The method of any of aspects 1 through 4, where a unit comprises a bit, the method further including: spreading a first bit or a first bit pair of a first bit sequence of the plurality of sequences by the OCC code word to generate a first OCC encoded sequence of the plurality of OCC encoded sequences.

Aspect 6: The method of aspect 5, further including: applying one or more bit flip operations to the first bit or the first bit pair of the plurality of sequences based at least in part on the OCC code word, where the first bit or the first bit pair in the plurality of sequences is modulated via binary phase shift keying or quadrature phase shift keying, and where at least one element of the OCC code word indicates a phase shift value corresponding to zero degrees or one-hundred eighty degrees.

Aspect 7: The method of any of aspects 5 through 6, where the multiplexing order parameter is a factor of a quantity of the plurality of clusters comprised in time-frequency resources allocated to the UE for communication of the plurality of OCC encoded sequences over the plurality of clusters.

Aspect 8: The method of any of aspects 1 through 7, where transmitting the plurality of OCC encoded sequences comprises: transmitting shared channel signaling, control channel signaling, reference signaling, or any combination thereof, that is generated based at least in part on the plurality of OCC encoded sequences.

Aspect 9: The method of any of aspects 1 through 8, where the OCC code word is associated with an orthogonal matrix.

Aspect 10: The method of any of aspects 1 through 9, where the plurality of clusters are consecutive in time or are non-consecutive in time.

Aspect 11: A method for wireless communications at a network entity, including: obtaining an indication of a capability of a UE to support OCC multiplexing; outputting, based at least in part on the indication, control signaling indicating a multiplexing order parameter, an OCC code word that the UE is to apply for OCC multiplexing, and a quantity of units comprised in each cluster in which the UE is to apply OCC multiplexing; and obtaining, over a plurality of clusters, an OCC multiplexed message including a plurality of OCC encoded sequences, the plurality of OCC encoded sequences including a plurality of sequences encoded by the OCC code word in accordance with the multiplexing order parameter and the quantity of units.

Aspect 12: The method of aspect 11, where the indication of the capability of the UE to support OCC multiplexing is based at least in part on one or more phase coherence capabilities of the UE.

Aspect 13: The method of any of aspects 11 through 12, where a quantity of the plurality of OCC encoded sequences corresponds to the multiplexing order parameter.

Aspect 14: The method of any of aspects 11 through 13, where a unit comprises a bit, a symbol, a resource element, a mini-slot, or a slot; and a cluster of the plurality of clusters comprises a plurality of symbols, a plurality of resource elements, a plurality of mini-slots, or a plurality of slots.

Aspect 15: The method of any of aspects 11 through 14, where a unit comprises a bit; and a first OCC encoded sequence of the plurality of OCC encoded sequences is based at least in part on a first bit or a first bit pair of a first bit sequence of the plurality of sequences being spread by the OCC code word.

Aspect 16: The method of aspect 15, where the first OCC encoded sequence of the plurality of OCC encoded sequences is based at least in part on one or more bit flip operations being applied to the first bit or the first bit pair of the plurality of sequences in accordance with the OCC code word, the first bit or the first bit pair in the plurality of sequences is modulated via binary phase shift keying or quadrature phase shift keying, and at least one element of the OCC code word indicates a phase shift value corresponding to zero degrees or one-hundred eighty degrees.

Aspect 17: The method of any of aspects 15 through 16, where the multiplexing order parameter is a factor of a quantity of the plurality of clusters comprised in time-frequency resources allocated to the UE for communication of the plurality of OCC encoded sequences over the plurality of clusters.

Aspect 18: The method of any of aspects 11 through 17, where the plurality of OCC encoded sequences are comprised in shared channel signaling, control channel signaling, reference signaling, or any combination thereof.

Aspect 19: The method of any of aspects 11 through 18, where the OCC code word is associated with an orthogonal matrix.

Aspect 20: A UE for wireless communications, including one or more memories storing processor-executable code, a transceiver, and one or more processors coupled with the one or more memories and individually or collectively operable to execute the code to cause the UE to perform a method of any of aspects 1 through 10.

Aspect 21: A UE for wireless communications, including at least one means for performing a method of any of aspects 1 through 10.

Aspect 22: A non-transitory computer-readable medium storing code for wireless communications, the code including instructions executable by one or more processors to perform a method of any of aspects 1 through 10.

Aspect 23: A network entity for wireless communications, including one or more memories storing processor-executable code, and one or more processors coupled with the one or more memories and individually or collectively operable to execute the code to cause the network entity to perform a method of any of aspects 11 through 19.

Aspect 24: A network entity for wireless communications, including at least one means for performing a method of any of aspects 11 through 19.

Aspect 25: A non-transitory computer-readable medium storing code for wireless communications, the code including instructions executable by one or more processors to perform a method of any of aspects 11 through 19. It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code;
a transceiver; and
one or more processors coupled with the one or more memories and individually or collectively configured to:
transmit, via the transceiver, an indication of a capability of the UE to support orthogonal cover code (OCC) multiplexing;
receive, via the transceiver, based at least in part on the indication, control signaling indicating a multiplexing order parameter, an OCC code word that the UE is to apply for OCC multiplexing, and a quantity of units comprised in each cluster in which the UE is to apply OCC multiplexing; and
transmit, via the transceiver and over a plurality of clusters, an OCC multiplexed message comprising a plurality of OCC encoded sequences, the plurality of OCC encoded sequences comprising a plurality of sequences encoded by the OCC code word in accordance with the multiplexing order parameter and the quantity of units.

2. The UE of claim 1, wherein:
the capability of the UE to support OCC multiplexing is based at least in part on one or more phase coherence capabilities of the UE.

3. The UE of claim 1, wherein the one or more processors are individually or collectively further configured to:
apply the OCC code word to the plurality of sequences to generate the plurality of OCC encoded sequences, wherein a quantity of the plurality of OCC encoded sequences corresponds to the multiplexing order parameter.

4. The UE of claim 1, wherein:
a unit of the quantity of units comprises a bit, a symbol, a resource element, a mini-slot, or a slot; and
a cluster of the plurality of clusters comprises a plurality of symbols, a plurality of resource elements, a plurality of mini-slots, or a plurality of slots.

5. The UE of claim 1, wherein a unit of the quantity of units comprises a bit, and the one or more processors are individually or collectively further configured to:
spread a first bit or a first bit pair of a first bit sequence of the plurality of sequences by the OCC code word to generate a first OCC encoded sequence of the plurality of OCC encoded sequences.

6. The UE of claim 5, wherein the one or more processors are individually or collectively further configured to:
apply one or more bit flip operations to the first bit or the first bit pair of the plurality of sequences based at least in part on the OCC code word, wherein the first bit or the first bit pair in the plurality of sequences is modulated via binary phase shift keying or quadrature phase shift keying, and wherein at least one element of the OCC code word indicates a phase shift value corresponding to zero degrees or one-hundred eighty degrees.

7. The UE of claim 1, wherein the multiplexing order parameter is a factor of a quantity of the plurality of clusters comprised in time-frequency resources allocated to the UE for communication of the plurality of OCC encoded sequences over the plurality of clusters.

8. The UE of claim 1, wherein, to transmit the plurality of OCC encoded sequences, the one or more processors are individually or collectively configured to:
transmit, via the transceiver, shared channel signaling, control channel signaling, reference signaling, or any combination thereof, that is generated based at least in part on the plurality of OCC encoded sequences.

9. The UE of claim 1, wherein the OCC code word is associated with an orthogonal matrix.

10. The UE of claim 1, wherein:
the plurality of clusters are consecutive in time or are non-consecutive in time.

11. A network entity, comprising:
one or more memories storing processor-executable code; and
one or more processors coupled with the one or more memories and individually or collectively configured to:
obtain an indication of a capability of a user equipment (UE) to support orthogonal cover code (OCC) multiplexing;
output, based at least in part on the indication, control signaling indicating a multiplexing order parameter, an OCC code word that the UE is to apply for OCC multiplexing, and a quantity of units comprised in each cluster in which the UE is to apply OCC multiplexing; and
obtain, over a plurality of clusters, an OCC multiplexed message comprising a plurality of OCC encoded sequences, the plurality of OCC encoded sequences comprising a plurality of sequences encoded by the OCC code word in accordance with the multiplexing order parameter and the quantity of units.

12. The network entity of claim 11, wherein:
the indication of the capability of the UE to support OCC multiplexing is based at least in part on one or more phase coherence capabilities of the UE.

13. The network entity of claim 11, wherein a quantity of the plurality of OCC encoded sequences corresponds to the multiplexing order parameter.

14. The network entity of claim 11, wherein:
a unit of the quantity of units comprises a bit, a symbol, a resource element, a mini-slot, or a slot; and
a cluster of the plurality of clusters comprises a plurality of symbols, a plurality of resource elements, a plurality of mini-slots, or a plurality of slots.

15. The network entity of claim 11, wherein:
a unit of the quantity of units comprises a bit, and
a first OCC encoded sequence of the plurality of OCC encoded sequences is based at least in part on a first bit or a first bit pair of a first bit sequence of the plurality of sequences being spread by the OCC code word.

16. The network entity of claim 15, wherein:
the first OCC encoded sequence of the plurality of OCC encoded sequences is based at least in part on one or more bit flip operations being applied to the first bit or the first bit pair of the plurality of sequences in accordance with the OCC code word;
the first bit or the first bit pair in the plurality of sequences is modulated via binary phase shift keying or quadrature phase shift keying; and
at least one element of the OCC code word indicates a phase shift value corresponding to zero degrees or one-hundred eighty degrees.

17. The network entity of claim 11, wherein the multiplexing order parameter is a factor of a quantity of the plurality of clusters comprised in time-frequency resources allocated to the UE for communication of the plurality of OCC encoded sequences over the plurality of clusters.

18. The network entity of claim 11, wherein the plurality of OCC encoded sequences are comprised in shared channel signaling, control channel signaling, reference signaling, or any combination thereof.

19. The network entity of claim 11, wherein the OCC code word is associated with an orthogonal matrix.

20. A method for wireless communications at a user equipment (UE), comprising:
transmitting an indication of a capability of the UE to support orthogonal cover code (OCC) multiplexing;
receiving, based at least in part on the indication, control signaling indicating a multiplexing order parameter, an OCC code word that the UE is to apply for OCC multiplexing, and a quantity of units comprised in each cluster in which the UE is to apply OCC multiplexing; and
transmitting, over a plurality of clusters, an OCC multiplexed message comprising a plurality of OCC encoded sequences, the plurality of OCC encoded sequences comprising a plurality of sequences encoded by the OCC code word in accordance with the multiplexing order parameter and the quantity of units.
